(19) United States
(12) Patent Application Publication
(10) Pub. No.: US 2009/0211341 A1
(43) Pub. Date: Aug. 27, 2009

(54) Leakage Detection Based on Fluid Property Changes

(76) Inventor: Klaus Witt, Keltern (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/988,082

(22) PCT Filed: Jun. 29, 2005
(86) PCT No.: PCT/EP2005/053066

§ 371 Date: Mar. 11, 2009

(51) Int. Cl. G01M 3/04; F04B 43/12; B01D 15/08

(52) U.S. Cl. 73/49.8; 417/474; 210/198.2

(57) ABSTRACT

A leakage detection system is described, with the leakage detection system comprising a fluid chamber (8) containing a first fluid, and a sealing element (12) located between the fluid chamber and a second fluid chamber (15), said sealing element (12) being adapted for sealing the first fluid in the fluid chamber (8), and the second fluid chamber (15) being located adjacent the sealing element and containing a second fluid. The leakage detection system further comprises a detection unit (19) in fluid connection with the second fluid chamber, said detection unit being adapted for detecting leakage by evaluating a property of the second fluid, with said property being affected by first fluid leaking into the second fluid.

### BACKGROUND ART

The present invention relates to a leakage detection system, to a fluid separation system, and to a pumping apparatus. The invention further relates to a method for detecting leakage of a sealing element.

U.S. Pat. No. 6,523,630 “Method and Apparatus for Monitoring a Fluid System” discloses an apparatus for monitoring a fluid system particularly suited for use with high pressure liquid chromatography systems. The apparatus monitors seal leakage as well as the general wellness of the apparatus and can thus be used to provide preventive maintenance feedback.

### DISCLOSURE

It is an object of the invention to provide an improved leakage detection. The object is solved by the independent claim(s). Preferred embodiments are shown by the dependent claim(s).

A leakage detection system according to embodiments of the present invention comprises a fluid chamber containing a first fluid, and a sealing element located between the fluid chamber and a second fluid chamber, said sealing element being adapted for sealing the first fluid in the fluid chamber, and the second fluid chamber being located adjacent the sealing element and containing a second fluid. The leakage detection system further comprises a detection unit in fluid connection with the second fluid chamber, said detection unit being adapted for detecting leakage by evaluating a property of the second fluid, with said property being affected by first fluid leaking into the second fluid.

Sealing elements are among the most stressed wear parts of a fluid handling systems. In case the sealing element adapted for sealing the fluid chamber becomes leaky, first fluid will leak into the second fluid chamber. The detection unit is adapted for monitoring a property of the second fluid, with this property being affected by the presence of first fluid. Hence, at the detection unit, a change of the second fluid's property will be observed, with this change being due to first fluid bleeding into the second fluid. Thus, leakage of the sealing element can be identified, and the user may replace the sealing element before measurement results are impaired or any further damage occurs.

The property determined by the detection unit may be chosen such that said property is significantly affected by the presence of tiny amounts of first fluid. Thus, it is possible to provide a highly sensitive leakage detection that is capable of identifying leakage of a sealing element at a very early stage. The user is informed about the defective seal and may replace it before errors related to leakage become dramatic. By employing a leakage detection system according to embodiments of the present invention, it is possible to perform preventive maintenance monitoring of the sealing elements in a fluid handling system. By replacing wear parts such as seals in due time, downtime of high performance systems, e.g. of high performance analysis systems used for chemical, biological and biochemical applications, can be reduced.

According to a preferred embodiment of the invention, the amount of first fluid bleeding into the second fluid per unit time determines how much the measured property is affected. A large leakage flow gives rise to a significant change of the measured property, whereas trace amounts of first fluid bleeding into the second fluid do not affect the measured property that much. In this regard, the measured property indicates how severe the problems due to leakage are.

In a preferred embodiment, the system comprises an element extending from the fluid chamber's outside through the sealing element into the fluid chamber, with the sealing element being realized as a ring-shaped sealing element adapted for sealing the fluid chamber. For example, the element might be a reciprocating element that moves relative to the seal. Due to friction, the sealing element might wear out prematurely, and leakage is likely to occur. By performing leakage monitoring using a leakage detection system according to embodiments of the present invention, defective sealing elements can be identified as early as possible.

According to another preferred embodiment, the leakage detection system is used for monitoring leakage of a piston pump, with the fluid chamber being a piston chamber, and with a reciprocating piston extending through a sealing element into the piston chamber. In a further preferred embodiment, the sealing element is adapted for sealing the piston relative to the piston chamber's housing. In this embodiment, the ring-shaped sealing element is adapted for sealing up the piston chamber. During the piston's down stroke, the pressure in the piston chamber might become quite large, and first fluid contained in the piston chamber might leak through the sealing element into the second fluid chamber. In case of leakage, the piston pump is no longer capable of accurately supplying a predefined flow rate. In fact, undetected seal wear is by far the most frequent reason for unexpected pump downtime. By continuously monitoring the state of the pump's seals, proper operation of the piston pump can be guaranteed.

According to a preferred embodiment, the pump chamber's inlet is equipped with an inlet valve, which might e.g. be a check valve. During the piston's up stroke, first fluid is drawn into the pump chamber. Then, during the piston's down stroke, backflow of the first fluid is prevented by said inlet valve. According to yet another preferred embodiment, the pump chamber's outlet comprises an outlet valve, which might e.g. be implemented as a check valve. The outlet valve is adapted for preventing backflow during the piston's upwards stroke. Then, during the down stroke, the outlet valve opens up, in order to supply a flow of first fluid.

According to a preferred embodiment, the property determined by the detection unit is compared with a predefined reference value. Said reference value corresponds to the case that the second fluid does not contain any amount of first fluid. If the sealing element is untight and first fluid leaks through the sealing element into the second fluid, the measured property will differ from the predefined reference value. In this embodiment, any deviation between the measured property and the predefined reference value indicates that the sealing element is defective.

According to another preferred embodiment, the property of the second fluid determined by the detection unit is compared with a predefined threshold. The threshold value may either represent an upper limit or a lower limit of the allowed value range of the second fluid's respective property. In case the presence of first fluid in the second fluid chamber gives rise to an increase of the measured property, the threshold represents an upper limit of the allowed range of values. In this case, if the measured property exceeds the threshold, the sealing element will be identified as being leaky. However, the presence of first fluid in the second fluid chamber might as well lead to a reduction of the measured property of the second fluid. In this case, the threshold represents a lower limit for the allowed range of values. In this case, the seal will be identified as being leaky if the measured property remains below this predefined threshold.

In a preferred embodiment, the detection unit is adapted for requesting replacement of a leaky seal at a point of time where leakage is still small. Thus, the user may replace the defective seal before any serious damage occurs. This concept is often referred to as “preventive maintenance monitoring”. Preventive maintenance monitoring allows reducing a system's downtime by constantly monitoring performance of the system's most stressed wear parts.

According to yet another preferred embodiment, any loss of first fluid that is due to leakage is compensated for by superposing a correction upon the piston movement. For example, a detected leakage rate might be compensated for by increasing the piston speed accordingly. Thus, a precise constant rate of fluid delivery can be assured even in case of acceptable leakage rates being present.

According to a preferred embodiment, the leakage detection system comprises a flow generating device adapted for generating a flow of second fluid that is conveyed through the second fluid chamber. By means of the flow of second fluid, first fluid that has leaked into the second fluid chamber is transported to the detection unit, and there, a respective property of the second fluid is determined. Besides that, by supplying a flow of second fluid, the rear side of the sealing element is kept clean. In this regard, the second fluid is used as a wash fluid. In particular, in case of a salt-containing eluent, the growth of salt crystals on the rear side of the seal is prevented.

In a preferred embodiment, the flow generating device is an auxiliary pump, e.g. a peristaltic pump. In a further preferred embodiment, the flow of second fluid might e.g. be generated by applying to the second fluid chamber's conduits at least one of: a subatmospheric pressure, a partial vacuum, an overpressure or any kind of pressure differential. For example, the flow of second fluid might be generated by connecting the second fluid chamber's conduits with different fluid levels.

According to a preferred embodiment, the flow generating device is adapted for modulating the flow of second fluid according to a continuous curve, e.g. according to a sinusoidal curve or a triangular curve. In this embodiment, the flow rate provided by the flow generating device is modulated in a more analogue manner.

According to another preferred embodiment, the flow generating device is operated in an intermittent mode of operation, with the flow generating device's duty cycle comprising an on-phase and an off-phase, whereby the lengths of the on-phase and the off-phase might be in the range of several minutes. If the sealing element is untight, first fluid will leak through the sealing element, and during the flow generating device's off-phase, the concentration of first fluid in the second fluid chamber will slowly increase. When the flow generating device is switched on, the content of the second fluid chamber is transported to the detection unit. There, a property of the second fluid is determined, said property being affected by the amount of first fluid that has leaked into the second fluid. Because of the increase of the second fluid's concentration during the off-phase of the flow generating device, the sensitivity of detection is improved, and even a small flow of first fluid leaking into the second fluid may be identified.

In a further preferred embodiment, the detection unit is adapted for correlating the measured property of the second fluid with the modulation of the flow through the second fluid chamber, in order to enhance detection.

According to a preferred embodiment, the leakage detection system is part of a high pressure fluid handling system. For example, the fluid chamber might be a piston chamber of a high pressure pump adapted for supplying a constant flow rate of first fluid at a pressure of 100 bar or more. In modern fluid delivery systems, dimensions of the fluid conduits get smaller and smaller, flow rates are reduced and system pressure is steadily increasing. As leakage rates often go linear with pressure, leakage of sealing elements tends to become a major limitation when designing fluid handling systems, especially in the low flow rate region.

According to preferred embodiments of the invention, the property of second fluid determined by the detection unit is a physical property of the second fluid.

According to preferred embodiments of the invention, the property is an electrical property of the second fluid, like e.g. conductivity, complex conductivity, impedance, resistance, reactance, relative permittivity, etc. For example, if the first fluid is a salt-containing eluent of high conductivity, small amounts of first fluid leaking into the second fluid might considerably increase the second fluid's conductivity. In this embodiment, leakage of the sealing element can be detected by evaluating an electrical property of the second fluid.

According to alternative embodiments of the invention, the detection unit is adapted for determining an optical property of the second fluid, with said optical property being affected by the presence of first fluid. For example, the detection unit might be adapted for evaluating optical absorbance of the second fluid, whereby first fluid leaking into the second fluid might either increase or decrease the second fluid's absorbance. Another possibility is to evaluate fluorescence intensity of the second fluid. For example, if the first fluid contains fluorescence labelled species and the second fluid does not contain any fluorescence labelled species, a rise of the detected fluorescence intensity will indicate leakage of the sealing element. Alternatively, in case the first fluid does not contain any fluorescence labelled species and the second fluid contains fluorescence labelled species, leakage of the sealing element causes a corresponding decrease of the detected fluorescence intensity. According to yet another preferred embodiment, the detection unit is adapted for determining the second fluid's refractive index, or changes thereof. For example, if one of the first and the second fluid is an organic solvent and the other one is an aqueous solution, there might be a significant difference between the two fluids' refractive indices. In this case, a certain amount of first fluid bleeding into the second fluid will significantly affect the second fluid's refractive index.

According to further embodiments, the presence of first fluid that has leaked into the second fluid is detected by evaluating a thermal property of the second fluid, like e.g. heat capacity and/or thermal conductivity of the second fluid. For this purpose, the detection unit might e.g. evaluate a temperature change of the second fluid that is obtained when applying a well-defined heat pulse to the second fluid. This detection technique might prove to be advantageous in cases where the first fluid's thermal properties differ considerably from the second fluid's thermal properties. For example, one might take advantage of the fact that the specific heat of an aqueous solution is significantly higher than the specific heat of certain organic solvents.

In a further preferred embodiment, the detection unit comprises a first electrode adapted for providing an electrical stimulus signal, preferably an AC signal, to a volume of second fluid. In a further preferred embodiment, the detection unit comprises a second electrode adapted for receiving an electrical response signal, e.g. an AC signal, in response to the stimulus signal. This response signal is used as a starting point for deriving any electrical property of the second fluid.

According to a preferred embodiment, the detection unit is adapted for performing a differential measurement of the second fluid's property. The property of the second fluid is determined after the second fluid has passed through the second fluid chamber, and from this value, the property of the second fluid before passing through the second fluid chamber is subtracted. Thus, a differential measurement is capable of determining the change of the respective property that is due to first fluid leaking into the second fluid while it passes through the second fluid chamber. The property determined at the inlet of the second fluid chamber is used as a reference value. By performing a differential measurement, the effects of varying external parameters like e.g. temperature changes, can be eliminated.

In a preferred embodiment, the detection unit comprises a differential refractive index detection unit, which is adapted for determining the change of the second fluid's refractive index when passing through the second fluid chamber. The second fluid's refractive index may strongly depend upon external parameters such as e.g. temperature. Therefore, it is advantageous to perform a differential measurement

In a preferred embodiment, the leakage detection system is implemented as part of a microfluidic chip device. Further preferably, the leakage detection system is implemented using microstructuring techniques such as laser ablation, hot embossing, etching, micromolding.

A leakage detection system according to a preferred embodiment of the invention comprises a set of fluid chambers containing their respective first fluid, a set of sealing elements, with each sealing element being adapted for sealing the respective first fluid in a corresponding fluid chamber, and a set of second fluid chambers containing a second fluid, with each of the second fluid chambers being located adjacent a corresponding sealing element. The second fluid chambers are fluidly connected in series. The leakage detection system further comprises a flow generating device adapted for conveying second fluid through the series connection of second fluid chambers, said flow generating device being adapted for pumping second fluid in an intermittent or modulated operation. A detection unit is adapted for detecting leakage of any of the sealing elements by evaluating said property of the second fluid. By connecting several second fluid chambers in series, leakage detection can be performed for a set of sealing elements. If trace amounts of first fluid leak through any of the sealing elements, the detection unit will detect a corresponding change of the second fluid's property. Thus, for monitoring proper operation of the sealing elements, only one flow generating device and one detection unit is required.

In a preferred embodiment, the flow generating device is operated in an intermittent mode of operation comprising an on-phase and an off-phase. By determining the time shift between the start of the flow generating device's operation and detection of a change of the second fluid's respective property, it is possible to identify which one of the sealing elements is defective. Then, instead of replacing all the sealing elements, only the defective sealing element is replaced.

A fluid separation system according to embodiments of the present invention comprises a pumping apparatus, the pumping apparatus comprising a leakage detection system as described above, and a separation device for separating components using the first fluid supplied by the pumping apparatus.

Embodiments of the invention can be partly or entirely embodied or supported by one or more suitable software programs, which can be stored on or otherwise provided by any kind of data carrier, and which might be executed in or by any suitable data processing unit. Software programs or routines are preferably applied for detecting leakage by evaluating a property of the second fluid, said property being affected when first fluid leaks into the second fluid.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawing(s). Features that are substantially or functionally equal or similar will be referred to by the same reference sign(s).

FIG. 1 shows a leakage detection system according to embodiments of the present invention;

FIG. 2 shows a sealing element for use in high pressure applications;

FIG. 3 depicts an embodiment of the present invention, wherein an electrical property of the second fluid is monitored;

FIG. 4 depicts embodiments of a leakage detection system adapted for performing a differential measurement; and

FIG. 5 shows a set of second chambers fluidly connected in series.

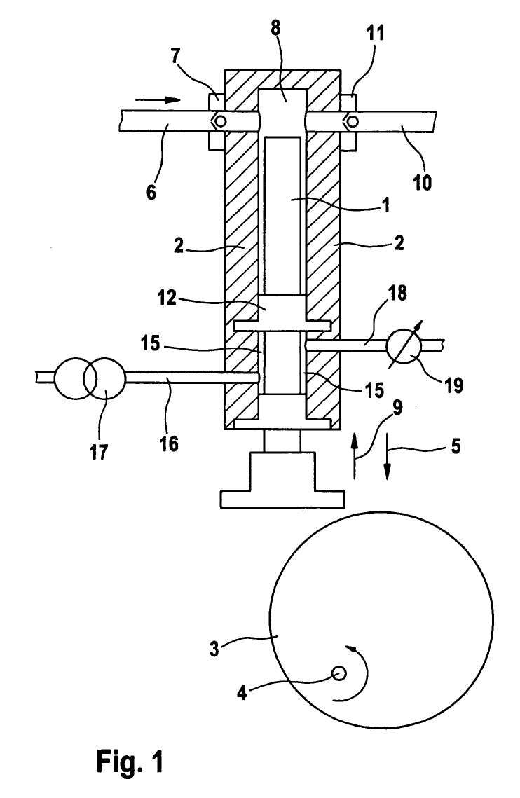

FIG. 1 shows a piston pump according to embodiments of the present invention, with the piston pump comprising a piston 1 that performs a back-and-forth movement within the housing 2. The piston 1 may be driven by a cam 3 rotating around an axis 4. During the piston's downward movement (5), liquid phase is aspirated via an inlet 6. In order to prevent backflow, the inlet 6 might be equipped with a check valve 7. After the pump chamber 8 has been filled with liquid, the piston 1 performs an upward movement (9), in order to displace the liquid until system pressure is reached and liquid is dispensed through the outlet 10, which might be equipped with a check valve 11. Thus, the piston pump is operable both for generating sufficient pressure, and for supplying a certain volume of liquid per unit time.

Due to the small dimensions of microfluidic systems, flow rates are ever decreasing while system pressures of more than 100 bar are utilized. Precise liquid dispensing is required. In order to cope with these needs, plungers formed of sapphire or ceramics are employed. Furthermore, the piston pump comprises a ring-shaped high pressure sealing element 12, with the reciprocating piston 1 extending through the sealing element 12 into the pump chamber 8.

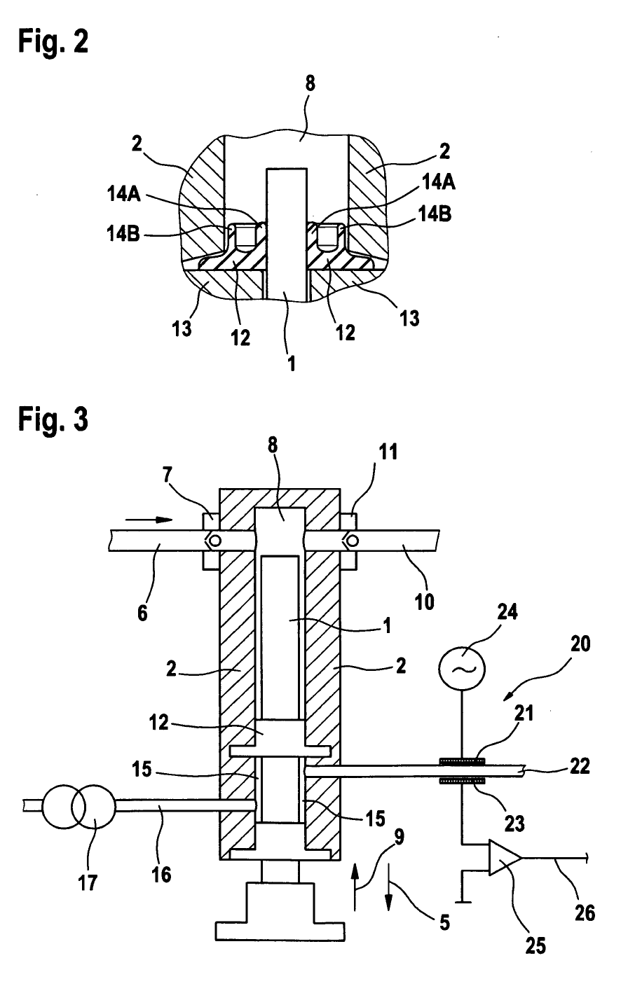

In FIG. 2, the ring-shaped sealing element, which is located between the reciprocating piston 1 and the pump chamber's housing 2, is shown in more detail. The sealing element 12 might e.g. be made of a polymeric material. The sealing element 12 is fixed by a seal support 13. The sealing element 12 comprises a first circumferential lip 14A that is pressed against the piston surface by the pressure built up in the pump chamber 8. The sealing element 12 further comprises a second circumferential lip 14B that is pressed against the pump's housing by the pressure built up in the pump chamber 8. As a result, a tight fit of the sealing element 12 is accomplished.

As the piston 1 moves to aspirate new eluent, small amounts of eluent residing in the pump chamber 8 are commonly transported by the piston surface through the sealing element 12 to the backside of the sealing element 12. If a salt-containing eluent is used, as e.g. in biochemical applications, salt crystals may build up after a few pump strokes on the backside of the seal. Such crystals are often sharp and can destroy the seal surface within a few piston strokes.

The piston pump of FIG. 1 comprises a second chamber 15 located adjacent to the rear side of the sealing element 12. The second chamber's inlet 16 is fluidly connected with an auxiliary pump 17, which might e.g. be a peristaltic pump. The auxiliary pump 17 is adapted for conveying a flow of second fluid through the second chamber 15. An aqueous wash solution might be used as a second fluid. Due to the flow of wash fluid, the piston's surface is kept wet, and the growth of salt crystals on the rear side of the seal is prevented. The aqueous wash solution might comprise a small amount of organic solvent. This organic addition to the second fluid prevents growth of algae and fungi inside the second chamber 15. According to embodiments of the present invention, the second chamber's outlet 18 is fluidly connected with a detection unit 19, with the detection unit 19 being adapted for determining a property of the second fluid that is affected by the presence of small amounts of eluent leaking through the sealing element 12. The property might e.g. be an electrical property, an optical property, or a thermal property of the second fluid, with said property being affected by the presence of trace amounts of eluent. By continuously monitoring this property, leakage of the sealing element 12 can be detected at an early stage, and a warning signal might be provided to inform the user that the high pressure sealing element 12 should be replaced. This feature is often referred to as preemptive maintenance feedback, because it enables the user to replace the sealing element 12 at its end of lifetime before further damages occur.

Piston seals are known to be one of the most critical wear parts. Due to the increase of pressure in high pressure solvent handling systems, and due to the reduced dimensions of such systems, even minor leakage rates will tend to become a major problem in future system designs. For example, in applications related to high performance liquid chromatography (HPLC), it is the interest to increase peak capacity, which is the total number of peaks per time interval. In order to accomplish this goal, the dimensions of a separation column get smaller and smaller. While separation columns having an inner diameter of 4.6 mm are currently in use, future columns will tend to have an inner diameter below 0.5 mm. Besides that, the size of the packing material is decreased. In future separation columns, packing materials with particle sizes in the sub micron range will be used. Furthermore, eluent flow conveyed through the separation column is reduced: currently, flow rates of 1-2 m/min are used, whereas in future applications, eluent flow rates as small as 50 μl or less will be employed. Because of the reduced dimensions of future separation columns, the pressure required to drive an eluent through a packed column has to be increased. Currently, pressures of about 400 bar are used. In future applications, it will become necessary to use pressures of about 800 bar.

In summary, piston pumps suitable for future HPLC applications have to be capable of supplying eluent at pressures of above 800 bar and at flow rates below 50 μl/min. In this context, it is obvious that even small leakage rates may cause non- negligible errors.

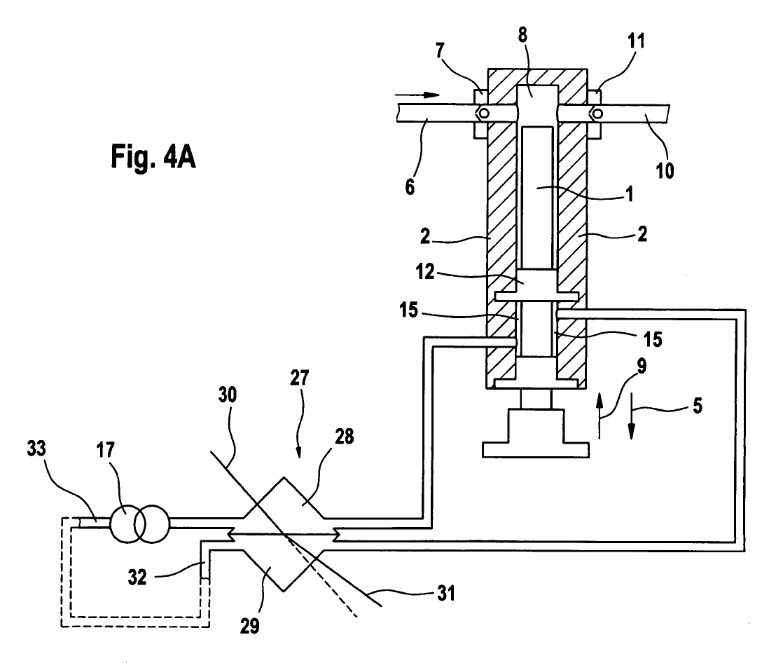

FIG. 3 shows another embodiment of the invention, whereby features that are functionally equal or similar to those shown in FIG. 1 are referred to by the same reference signs. In the embodiment shown in FIG. 3, the detection unit is implemented as a conductivity detection unit 20. The conductivity detection unit 20 comprises a first electrode 21 adapted for coupling an AC stimulus signal to the second fluid flowing in the fluid conduit 22, and a second electrode 23 adapted for receiving a response signal in response to the AC stimulus signal. The electrodes 21, 23 might be in direct contact with the second fluid flowing in the fluid conduit 22. Alternatively, the conductivity detection cell 20 might be realized as a contactless conductivity detection cell, with the electrodes 21, 23 being adapted for capacitively coupling an AC signal to the second fluid. The AC stimulus signal is generated by an AC signal generator 24. The AC response signal received by the electrode 23 is forwarded to an amplification unit 25, which might e.g. be realized as an operational amplifier. At the amplifier's output 26, an amplified AC response signal is obtained. This AC response signal is used as a starting point for deriving an electrical property of the second fluid, like e.g. conductivity, complex conductivity, impedance, resistance, reactance, relative permittivity, etc. In addition to the magnitude of the AC response signal, the time shift between the AC stimulus signal and the AC response signal may be evaluated.

In case a salt-containing eluent is utilized, the embodiment shown in FIG. 3 is particularly well-suited for detecting leakage. Trace amounts of salt-containing eluent leaking through the sealing element 12 will considerably increase the second fluid's conductivity.

With regard to different kinds of eluents, other detection techniques might prove to be useful. For example, the presence of small amounts of eluent might be detected by monitoring an optical property of the second fluid, such as e.g. the second fluid's optical absorption. In this case, the detection unit comprises a light source, e.g. a laser source, and a detector adapted for determining the intensity of the transmitted light. In yet another preferred embodiment, the eluent might comprise a certain amount of fluorescent dye, and the detection unit might be implemented as a fluorescence detection unit comprising a light source and a detector adapted for detecting fluorescence intensity.

Further alternatively, the detection unit might be adapted for detecting thermal properties of the second fluid, such as e.g. heat capacity or thermal conductivity of the second fluid. For this purpose, a well-defined heat pulse is applied to the flow of second fluid, and the resulting temperature change is analyzed. By relating the resulting temperature change to the applied heat pulse, it is possible to derive thermal properties of the second fluid. In case an aqueous solution is used as a second fluid, the second fluid's heat capacity is quite high. In contrast, a heat capacity of an organic eluent might e.g. be quite small. For this reason, organic solvent leaking through the sealing element might significantly affect the second fluid's heat capacity.

According to a first embodiment, the auxiliary pump 17 is operating in a continuous mode of operation. In this continuous mode of operation, a steady flow of second fluid is conveyed through the second chamber 15. According to an alternative embodiment, the flow generated by the auxiliary pump 17 is modulated according to a continuous characteristic. In yet another embodiment, the auxiliary pump 17 is operated in an intermittent mode of operation. For example, the auxiliary pump 17 may be alternatingly switched on and off according to a duty cycle. The time periods of the auxiliary pump's on-phases and off-phases may e.g. be in the range of minutes. As long as the auxiliary pump is switched off, eluent leaks through the sealing element 12, and accordingly, the concentration of eluent in the second chamber 15 is continuously increasing during the off-phase. After the start of the auxiliary pump's activity, the second chamber's content is conveyed to the detection unit, and there, a property indicating the presence of a certain amount of eluent is evaluated, in order to determine the amount of leakage. Due to the increase of concentration during the auxiliary pump's off-phase, the detection of trace amounts of said eluent is simplified.

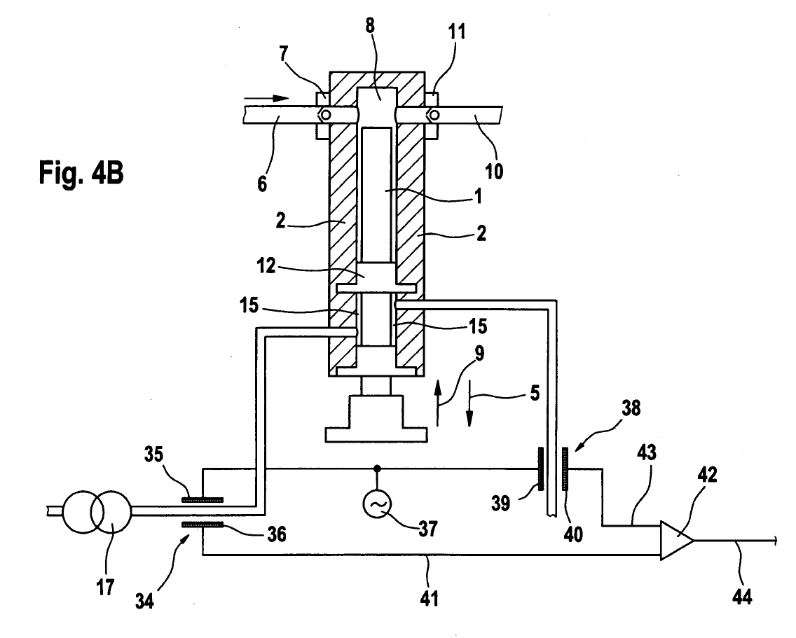

FIG. 4A shows another embodiment of the invention, whereby features that are substantially or functionally equal or similar to those shown in FIG. 1 are referred to by the same reference signs. In the embodiment shown in FIG. 4A, a refractive index detector 27 is used for detecting a change of the second fluid's refractive index by comparing the second fluid's refractive index before and after the second fluid has been conveyed through the second chamber 15. In case of eluent leaking through the sealing element 12, a change of the second fluid's refractive index is observed. Especially in the case of the eluent being an organic solvent and the second fluid being an aqueous solution, the second fluid's refractive index is significantly affected by the presence of small amounts of eluent.

The refractive index detector 27 comprises a reference flow cell 28 that is located upstream of the second chamber 15, and a sample flow cell 29 located downstream of the second chamber 15. An incident light beam 30 is deflected while passing both through the reference flow cell 28 and the sample flow cell 29. The angle of deflection of the deflected beam 31 is detected, with the angle of deflection depending on the change of the second fluid's refractive index: the higher the amount of eluent leaking through the sealing element, the more the light beam will be deflected. The extent of deflection might e.g. be detected by means of a multisegment diode. A refractive index detector 27 as shown in FIG. 4A is capable of covering the entire refractive index range from 1.000 to 1.750 with a single cell.

The refractive index detector 27 is adapted for performing a differential measurement of the refractive index. The second fluid's refractive index is determined both before and after the second chamber 15. Thus, the change of the refractive index when passing the second chamber is determined, with the refractive index before the second chamber 15 being used as a reference value. Thus, any fluctuations of the second fluid's refractive index induced by external parameters, e.g. by temperature changes, are eliminated.

According to yet another embodiment, such a differential approach like this refractive index detection unit allows utilizing a closed loop conduit, which is indicated in dashed lines. Second fluid obtained at the outlet 32 of the sample flow cell 29 is provided back to the inlet 33 of the auxiliary pump 17. In this embodiment, a certain volume of second fluid is permanently conveyed through the closed loop conduit. Thus, the second fluid is used over and over again until a certain end condition occurs, like e.g. end of a time span, or number of revolutions of the total volume.

If the sealing element 12 is untight, eluent might steadily bleed into the second fluid, and accordingly, the amount of eluent contained in the second fluid might continuously increase. By performing a differential measurement, it is possible to determine how much the second fluid's refractive index changes when the second fluid passes through the second chamber. In this respect, the refractive index's absolute value is of no importance. In fact, the refractive index's absolute value is treated as an arbitrary offset that does not affect the differential measurement of the refractive index. Therefore, it doesn't matter that the same volume of second fluid is used over and over again.

In the embodiment shown in FIG. 4B, the detection unit is adapted for performing a differential measurement of an electrical property of the second fluid. A first detection cell 34 is located upstream of the second chamber 15, with the first detection cell 34 comprising a first electrode 35 and a second electrode 36. The first electrode 35 is connected to an AC signal generator 37. A second detection cell 38 is located downstream of the second chamber 15, with the second detection cell 38 comprising a third electrode 39 and a fourth electrode 40. The third electrode 39 is connected to the AC signal generator 37.

From the second electrode 36, a first AC response signal 41 is received, which is forwarded to a first input of a differential amplifier 42. From the fourth electrode 40, a second AC response signal 43 is obtained, which is connected to a second input of the differential amplifier 42. At the output of the differential amplifier 42, an output signal 44 is obtained, said output signal 44 indicating a change of the second fluid's respective electrical property before and after the second fluid has passed through the second chamber 15. For example, if a salt-containing eluent leaks through the sealing element 12, there will be an increase of the second fluid's conductivity. Accordingly, the second AC response signal 43 will differ considerably from the first AC response signal 41, and the output signal 44 will indicate leakage of the sealing element 12.

Likewise in a microstructured detection cell with the detection cells 34, 38 being in proximate relation to each other, the first and third electrodes 35, 39 may be combined in a common electrode.

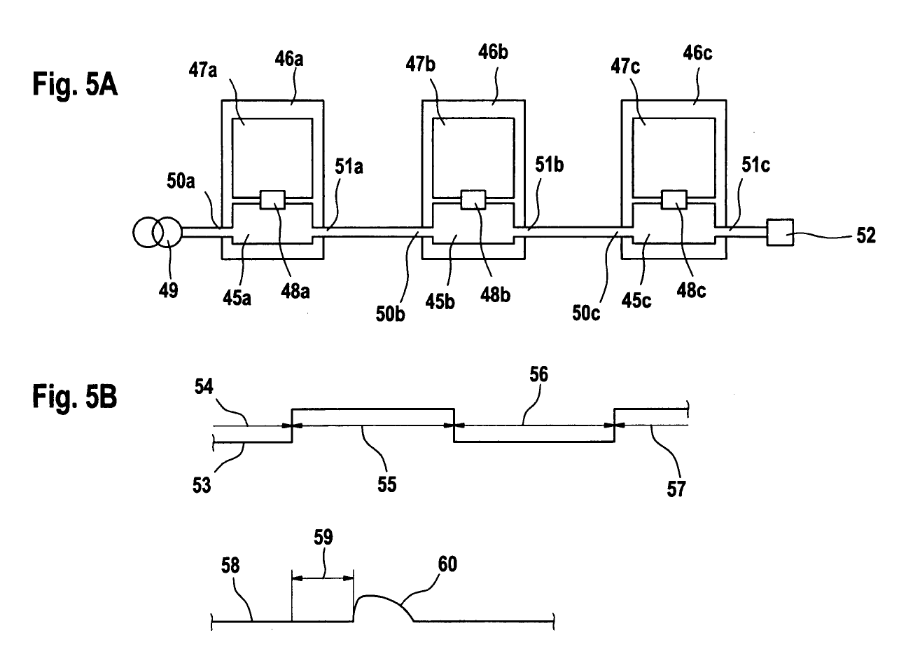

FIG. 5A shows another embodiment of the present invention, in which wash chambers 45a, 45b, 45c of three fluid handling devices 46a, 46b, 46c are fluidly connected in series. Each of the fluid handling devices 46a, 46b, 46c comprises a fluid chamber 47a, 47b, 47c with a corresponding sealing element 48a, 48b, 48c. Wash chamber 45a is located adjacent to the sealing element 48a, wash chamber 45b is adapted for monitoring leakage of a sealing element 48b, and wash chamber 45c is located adjacent to the sealing element 48c.

An auxiliary pump 49 is fluidly connected with the first wash chambers inlet 50a, said auxiliary pump 49 being adapted for supplying a flow of wash fluid. For realizing a series connection of the wash chambers 45a, 45b, 45c, the first wash chamber's outlet 51a is connected with the second wash chamber's inlet 50b. Accordingly, the second wash chambers outlet 51b is in fluid connection with the third wash chamber's inlet 50c. The third wash chamber's outlet 51c is fluidly connected with a detection unit 52, the detection unit 52 being adapted for detecting a property of the wash fluid. If one or more of the sealing elements become leaky and eluent bleeds into the wash fluid conduit, a corresponding change of the property measured by the detection unit 52 will be observed. Thus, it can be found out that there is a leakage problem in one or more of the piston pumps 46a, 46b, 46c.

Besides that, it is possible to find out which one of the sealing elements 48a, 48b, 48c is leaky. For this purpose, the flow of wash fluid is subjected to a modulation. For example, the auxiliary pump 49 might be operated in an intermittent mode of operation, in accordance with a duty cycle. Curve 53 in the upper part of FIG. 5B shows the pump's duty cycle as a function of time. During the time intervals 54, 56, the auxiliary pump 49 is turned off, and during the time intervals 55, 57, the pump is turned on.

Assuming that sealing element 48b is defective, eluent might leak from the fluid chamber 47b through the sealing element 48b into the wash chamber 45b. Therefore, during the off-phase of the auxiliary pump 49, the concentration of eluent in wash chamber 45b is continuously increasing. Then, the auxiliary pump 48 is switched on, and the contents of the wash chambers 45c, 45b, 45a are successively conveyed to the detection unit 52. The detection unit 52 is adapted for determining a property of the wash fluid, with said property depending upon the amount of eluent contained in the wash fluid.

In the lower part of FIG. 5B, curve 58 indicates the time dependence of the property measured by the detection unit 52. Time interval 59 denotes the period of time required for conveying the content of wash chamber 45b to the detection unit 52. As soon as the content of wash chamber 45b has arrived at the detection unit 52, a change 60 of the wash fluid's measured property is detected.

The length of the time interval 59 relates to the time needed for the content of a respective wash chamber to travel to the detection unit 52. Time interval 59 can be used for identifying which one of the wash chambers 45a, 45b, 45c contains some amount of eluent, and for identifying which one of the sealing elements 48a, 48b, 48c is defective. For example, in case sealing element 48c is leaky, time interval 59 will be much smaller than in case of sealing element 48a being defective. For example, in order to identify which one of the sealing elements 48a, 48b, 48c is defective, the length of time interval 59 might be compared with a set of predefined thresholds.

1. A pumping apparatus comprising
a pump chamber containing a first fluid, the pump chamber comprising an inlet and an outlet;
a piston reciprocating within the pump chamber;
a sealing element for sealing the piston relative to the pump chamber's housing;
a second fluid chamber located adjacent the sealing element, said second fluid chamber containing a second fluid,
a detection unit in fluid connection with the second fluid chamber, the detection unit being adapted for detecting leakage by monitoring a property of the second fluid, with said property being affected in case of first fluid leaking into the second fluid.

2. The pumping apparatus of claim 1, comprising at least one of:
said property depends on an amount of the first fluid bleeding into the second fluid;
said property is affected by the presence of trace amounts of first fluid that have leaked through any one of the sealing elements into the second fluid;
the sealing element is a ring-shaped sealing element adapted for sealing the piston relative to the fluid chamber;
the sealing element is adapted for sealing the piston relative to the housing of the piston chamber;
the pump chamber's inlet is equipped with an inlet valve;
the pump chamber's outlet comprises an outlet valve.

3. The pumping apparatus of claim 1, wherein the detection unit is adapted for at least one of:
comparing the property of the second fluid with a reference value;
comparing the property of the second fluid with a predefined threshold;
providing preventive maintenance feedback by indicating, in case of leakage, that the sealing element should be replaced;
correcting a supply rate of said piston pump in order to continue delivering a predefined flow rate of the first fluid.

4. The pumping apparatus of claim 1, further comprising a flow generating device adapted for conveying a flow of second fluid through the second fluid chamber.

5. The pumping apparatus of claim 4, further comprising at least one of:
the flow generating device is an auxiliary pump, preferably a peristaltic pump;
the flow generating device is adapted for generating the flow of second fluid by applying to the second fluid chamber's conduits at least one of: a subatmospheric pressure, a partial vacuum, an overpressure, a pressure differential, a fluid level difference;
the flow generating device is adapted for modulating the flow of second fluid in accordance with a continuous characteristic, preferably in accordance with a sinusoidal or a triangular characteristic;
the flow generating device is adapted for being operated in a duty cycle, with the duty cycle modulating the flow of second fluid through the second fluid chamber;
the detection unit is adapted for correlating the measured property of the second fluid with the modulation of the flow generated by the flow generating device, in order to enhance detection.

6. The pumping apparatus of claim 1, wherein the fluid chamber is part of a high-pressure system, wherein the first fluid in the fluid chamber can be subjected to high pressure, preferably to a pressure of more than 100 bar.

7. The pumping apparatus of claim 1, wherein the property of the second fluid determined by the detection unit is at least one of:
a physical property of the second fluid;
an electrical property of the second fluid;
electrical conductivity of the second fluid;
an optical property of the second fluid;
optical absorbance of the second fluid;
fluorescence of the second fluid,
refractive index of the second fluid;
a thermal property of the second fluid;
thermal conductivity of the second fluid.

8. The pumping apparatus of claim 1, comprising at least one of:
the detection unit comprises a first electrode adapted for coupling an AC signal to the second fluid;
the detection unit comprises a second electrode adapted for receiving an AC response signal in response to the AC signal;
the detection unit is adapted for performing a differential measurement that comprises determining said property of the second fluid before and after the second fluid has passed through the second fluid chamber;
the detection unit comprises a differential refractive index detection unit adapted for determining a difference between the second fluid's refractive index at the second fluid chamber's inlet and the second fluid's refractive index at the second fluid chamber's outlet.

9. The pumping apparatus of claim 1, further comprising at least one of:
the leakage detection system is implemented as part of a microfluidic chip device;
the leakage detection system is implemented using microstructuring techniques such as laser ablation, hot embossing, etching, micromolding.

10. The pumping apparatus of claim 1, comprising:
a set of fluid chambers containing their respective first fluid;
a set of sealing elements, with each sealing element being adapted for sealing the respective first fluid in a corresponding fluid chamber,
a set of second fluid chambers containing a second fluid, with each of the second fluid chambers being located adjacent a corresponding sealing element, said second fluid chambers being fluidly connected in series,
a flow generating device adapted for conveying second fluid through the series connection of second fluid chambers, said flow generating device being adapted for pumping second fluid in an intermittent or modulated operation,
wherein the detection unit is adapted for detecting leakage of any of the sealing elements by evaluating said property of the second fluid.

11. The pumping apparatus of claim 10, wherein said flow generating device is adapted for being operated in a duty cycle, with a time shift between start of the flow generating device's activity and detection of a contamination indicating which one of the sealing elements is defective.

12. A fluid separation system comprising
a pumping apparatus according claim 1, and
a separation device for separating components using the first fluid supplied by the pumping apparatus.

13. The fluid separation system of claim 12, wherein the fluid separation system is or comprises at least one of:
a chromatographic system,
a high performance fluid chromatographic system,
a high performance liquid chromatography arrangement comprising a chip and a mass spectrograph,
a high throughput liquid chromatography/mass spectroscopy system,
a purification system,
a micro fraction collection/spotting system,
a system adapted for identifying proteins,
a system comprising a gel permeation chromatography/size exclusion chromatography column,
a nanoflow liquid chromatography system, or
a multidimensional liquid chromatography system adapted for separation of protein digests.

14. A method for detecting leakage of a sealing element in a pumping apparatus comprising:
a pump chamber containing a first fluid,
a piston reciprocating within the pump chamber, wherein the sealing element is adapted for sealing the piston relative to the pump chamber's housing, and
a second fluid chamber located adjacent the sealing element, said second fluid chamber containing a second fluid,
the method comprising:
a) supplying a flow of a second fluid in a second fluid chamber located adjacent the sealing element; and
b) detecting leakage by evaluating a property of the second fluid, said property being affected when first fluid leaks into the second fluid.

15. The method of claim 14, further comprising at least one of:
comparing the property evaluated in b) with a reference value;
comparing the property of the second fluid with a predefined threshold in order to provide preventive maintenance feedback;
modulating the flow of the second fluid and correlating the measured property of the second fluid with the modulation of the flow, in order to enhance sensitivity;
evaluating said property of the second fluid before and after it has passed through the second fluid chamber, in order to allow for recycling of the second fluid.

16. A software program or product, embodied on a computer readable medium, for executing or controlling the method of claim 14, when run on a data processing system.
